(19) United States
(12) Patent Application Publication
(10) Pub. No.: US 2015/0294355 A1
(43) Pub. Date: Oct. 15, 2015

(54) COMPUTER-BASED COMMERCIAL MARKETPLACE SALES LEAD SCHEDULER

(71) Applicants: Payam Zamani, Danville, CA (US); Paul Charles O'Leary, San Francisco, CA (US)

(72) Inventors: Payam Zamani, Danville, CA (US); Paul Charles O'Leary, San Francisco, CA (US)

(21) Appl. No.: 14/253,832

(22) Filed: Apr. 15, 2014

(51) Int. Cl. G06Q 30/02; G06Q 10/06

(52) U.S. Cl. CPC G06Q 30/0255; G06Q 10/0631; G06Q 30/0277

(57) ABSTRACT

A system and a method are disclosed including a computer-implemented sales Lead Marketplace System (LMS) configured to provide sales leads or information associated with customers to merchants. In various embodiments, the lead marketplace presents a user interface, implemented using various software modules running on a computing device, to customers to specify their identities and the goods and services they seek. The customer information is packaged as a sales lead and sold to merchants via the lead marketplace. The LMS imports consumer and merchant calendars to coordinate the service schedule and sends automatic reminders to both to ensure service is performed as scheduled. LMS may also collect various information about the merchants and the customers, such as customer satisfaction, merchant's quality of work, merchant's and customer's behavior, and the like to build a profile for each to allow matching of customers and merchants for high quality results for both.

### CROSS-REFERENCE(S) TO RELATED APPLICATION(S)

This application is related to U.S. application Ser. No. 13/652,246, filed on 2 Jan. 2013, the disclosure of which is hereby expressly incorporated by reference in its entirety.

### TECHNICAL FIELD

This patent application relates generally to merchants and commercial platforms. More specifically, this application relates to a self-service computer-based commercial platform used as a marketing and customer relationship management tool.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example marketplace for trading commercial leads;

FIG. 4 shows an example scheduling interaction between customers, merchants, and sales Lead Marketplace System (LMS);

FIG. 5 shows an example marketing and advertisement interaction between customers, merchants, and sales LMS; and

FIG. 6 shows an example messaging interaction between customers, merchants, and sales LMS.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references a web-based user interface, it will be appreciated that the disclosure may be used with other types of user interface, such as application dialog boxes, server side windows, client side windows, and the like.

Briefly described, a system and a method are disclosed including a computer-implemented sales Lead Marketplace System (LMS) configured to provide sales leads or information associated with customers or consumers (goods and services buyers) to merchants (lead buyers and goods and service providers), which offer goods and services to the customers. In various embodiments, the lead marketplace presents a user interface, implemented using various software modules running on a computing device, to customers to specify their identities and the goods and services they seek. The customer information is packaged as a sales lead and sold to merchants via the lead marketplace. Associated with the sales leads are schedules which allow the coordination of the performance of the service between the customer and the merchant. In some embodiments, the LMS imports consumer and merchant calendars to coordinate the service schedule and sends automatic reminders to both to ensure service is performed as scheduled. LMS may also collect various information about the merchants and the customers, such as customer satisfaction, merchant's quality of work, merchant's and customer's behavior, and the like to build a profile for each to allow tailoring the matching of customers and merchants for high quality results for both.

The commercial success of a business depends on customers that may be first identified and approached through customer leads, which include customer identifying and/or contact information, as well customer needs, preferences, profile, age, income level, previous purchase history, and the like. Lead information may take any form, including online information, lists, referrals, and the like. As such, leads are valuable commodities and assets usable for sales and marketing activities, which leads themselves may be bought and sold in a lead marketplace. The internet is a particularly suitable medium for exchanging leads, for example, in an online lead marketplace, because real-time updates and quick actions can take place more easily than in other environments. However, obtaining leads is only the first step in making a successful sale to a customer. Easy and coordinated access to a lead marketplace, service scheduling, follow-up, status updates, and feedback are all important steps in the sales process.

### Illustrative Operating Environment

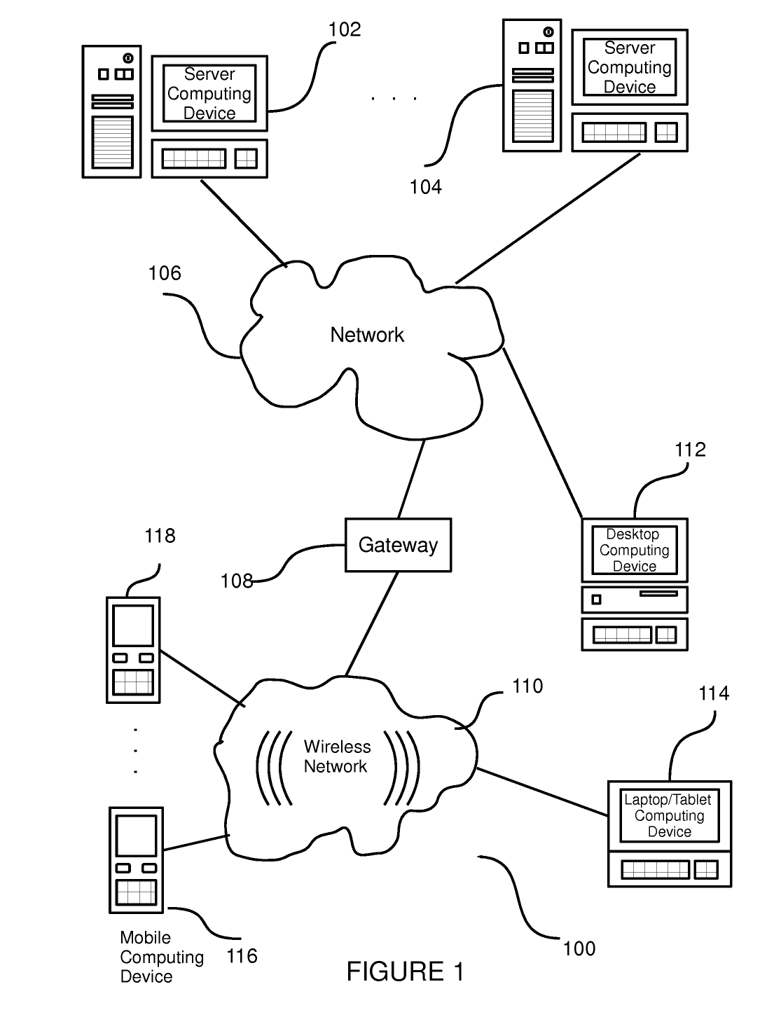

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

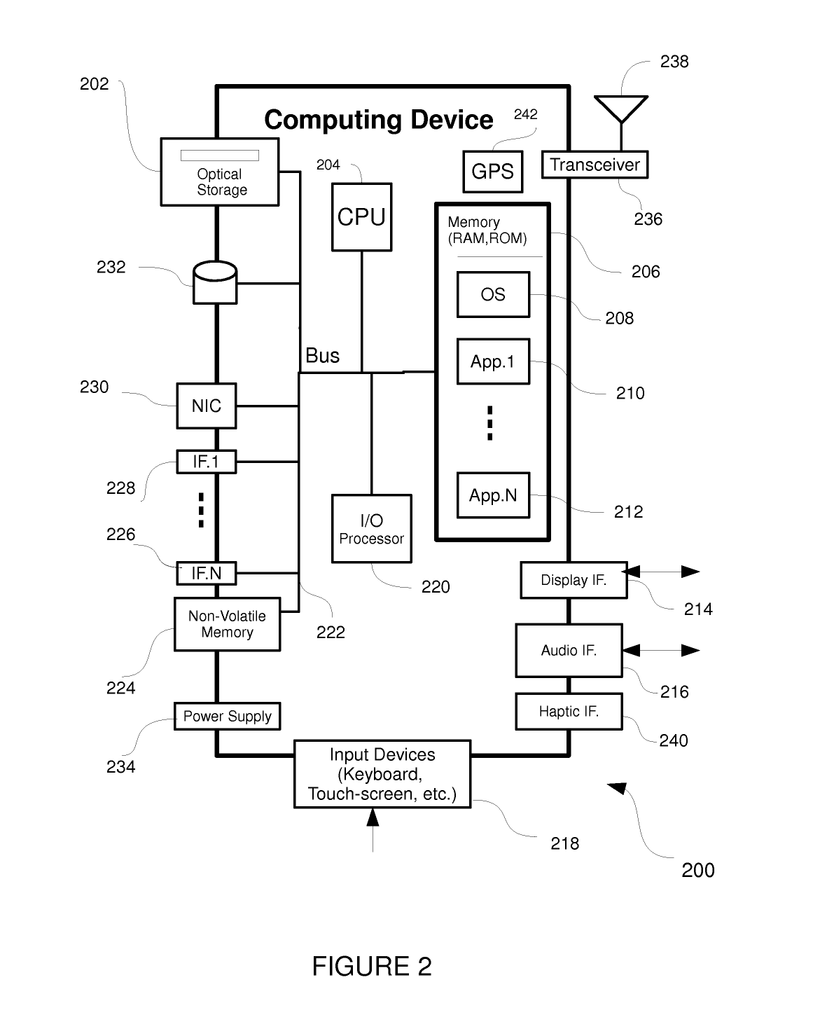

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send email and text messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs 210-212. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

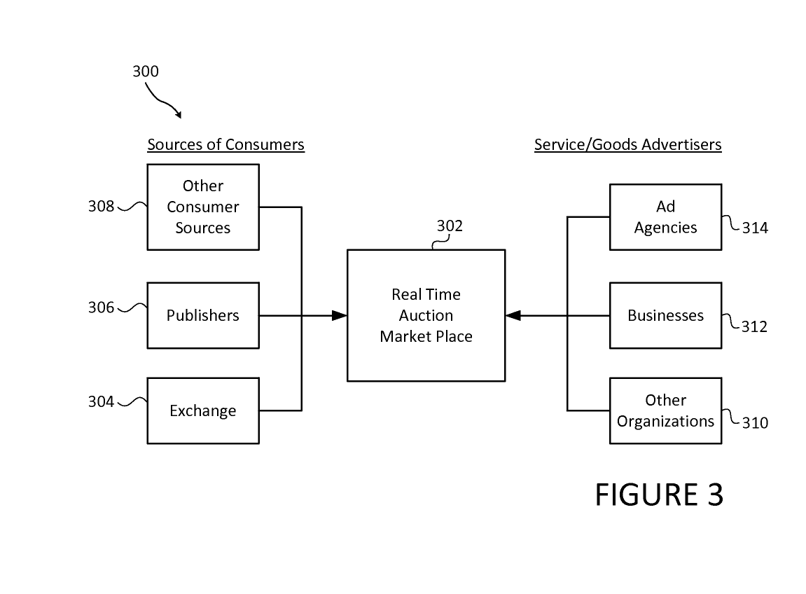

FIG. 3 shows an example marketplace for trading commercial leads. Marketplace 300 may include real time auction facility 302, sources of consumers including exchange boards 304, publishers 306, and other consumer sources 308; and service or product advertisers including advertising agencies 314, businesses 312, and other organizations 310.

In various embodiments, sales Lead Marketplace System (LMS) or auction facility 302 may be an online interface, such as a webpage, to which multiple users may log on to exchange sales leads. Generally, sales leads are potential customers for goods or services. Merchants are interested in obtaining a list of such potential customers to follow up and increase their sales volume. LMS 302 may thus be an electronic sales marketplace used to sell or buy sales leads for different industries, goods, or services. Service and/or good providers or advertisers are generally buyers of leads and sources of consumers are generally providers or sellers of consumer leads. For example, industry-specific exchanges such as contractor finding sites or other professional or commercial exchange sites may compile lists of highly relevant leads seriously looking for a specific types of goods or services, which may then be sold to other merchants in the same industry for follow-up. Similarly, publishers who publish and/or distribute advertisements may have access to highly relevant leads.

In various embodiments, the LMS provider may provide a user interface for accessing an electronic sales marketplace, obtaining sales leads, and going through the sales process in an orderly and timely manner to increase the utilization of the obtained leads. In some embodiments, the LMS is computer based and allows multiple merchants, advertisers, and generally lead buyers to log in and access the market. In other embodiments, the LMS provider may provide access to a private interface customized for a particular merchant by the LMS provider or a third party. In this embodiment, the merchant may be given the opportunity and computing facilities tailored to the merchant's business and practices and provide real time and/or aggregate data and statistics for its sales activities.

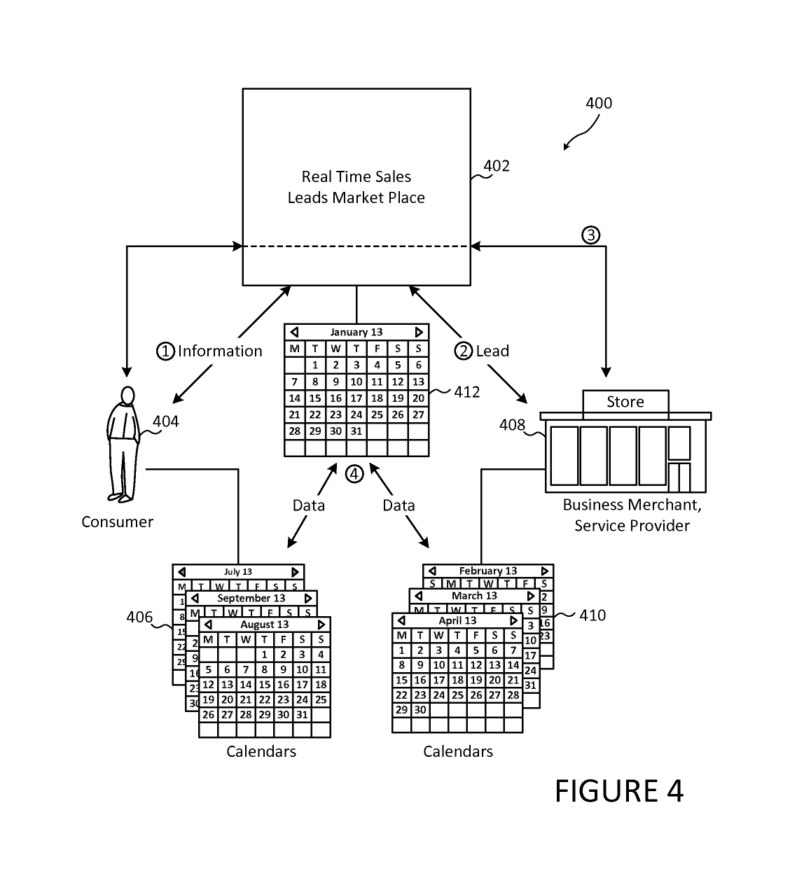

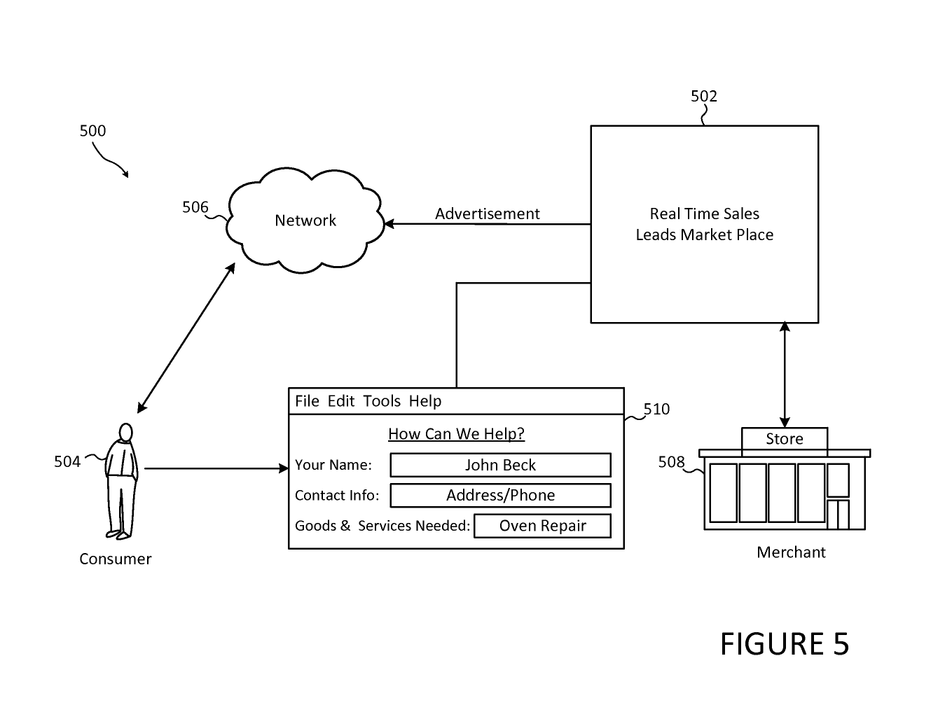

Once a lead is purchased or otherwise obtained by a merchant, it is desirable to quickly schedule a contact with the customer to further discuss customer needs or to schedule a time for the actual performance of the services the customer is interested in, as further described in FIGS. 4 and 5 below.

FIG. 4 shows an example scheduling interaction between customers, merchants, and sales Lead Marketplace System (LMS). In various embodiments, sales lead market place 400 includes LMS 402 connected with customer or consumer 404 associated with consumer calendar 406, and connected with business or merchant 408 associated with merchant calendar 410. A common scheduling calendar 412 may be used to coordinates dates on the consumer and merchant calendars.

In various embodiments, real-time LMS 402 is similar to real-time auction facility 302 of FIG. 3, and is configured to provide lead information for sale or purchase to the users of the lead marketplace. In some embodiments, the marketplace may be an electronic exchange, implemented using computing devices as described with respect to FIGS. 1 and 2, configured to allow electronic transactions to take place for the sale or purchase of leads and related data and information.

In various embodiments, LMS 402 may be implemented and presented by a hardware and/or software system using one or more software components executing on the illustrative computing device of FIG. 2. One or more functions may be performed by each software module. For example one or more separate software components may be used for each of the functions to manage user interface graphics, display tables or data items, database interface, scheduling and calendar processing, search for transactions or appointments, filter various records or data items based on various parameters, monitor consumer and/or merchant preferences, marketing and advertisement management, messaging and communications, and any other function needed to carry out and implement the functions of the LMS described herein. Those skilled in the art will appreciate that one function may implemented using multiple software modules or several functions may be implemented using one software module. With further reference to FIG. 2, these software modules are generally loaded into the memory module 206 of the computing device.

In various embodiments, the LMS may include servers such as web servers, application servers, message servers, email servers, database servers, marketing servers, back-end business servers, and the like. The web server may provide a user interface for access to information provided by LMS through the Internet. In some embodiments, other user interfaces may be provided via client-server model architecture in which a server side application communicates with a client side software application installed on the user's (consumer or merchant) computer and provide the user interface for acquiring information from the LMS. The message and email servers may provide communication and tracking facilities for interactions between the consumer, the LMS, and the merchants. The database servers may include database tables for merchant information, consumer information, merchant and consumer profiles, accounting information, marketing campaign information, sales promotion information, scheduling information, and other data as needed. In some embodiments, the backend business servers are coupled with the web servers and database servers to coordinate and manage communications, scheduling, and also service billings between the customer and the merchant based on business logic embedded in software modules.

Those skilled in the art will appreciate that multiple servers may be implemented as software modules on one or more hardware platforms. Also, some of the functions, such as user interface software and some of the backend business logic may implemented in one or more tightly integrated software modules, without departing from the spirit of the present disclosure.

The marketplace may include data about individual leads as well as statistical and/or aggregate data about the marketplace, or segments of the marketplace. In some embodiments, the LMS 402 may be specialized and configured to present leads in a particular market related to only certain goods and services, while in other embodiments, the marketplace may be configured as an open exchange for leads in most markets related to most goods and services. For example, a specialized marketplace may only offer leads for the real estate industry, the automotive industry, the hospitality industry, the farm industry, and the like, while a general marketplace may offer leads for substantially all vertical, cross-vertical, and horizontal markets.

In various embodiments, the LMS provider may be an organization which provides computing facilities and interface to the real-time LMS 402. For example, the LMS provider may provide a website for merchants to log in and access the marketplace for exchanging leads or monitor market conditions. In some embodiments the platform provider may also own and/or operate the real-time lead marketplace, while in other embodiments, the marketplace may be owned and/or operated by a third party, and the computing facilities provider may only provide the marketplace interface. Those skilled in the art will appreciate that the LMS provider may provide the marketplace interface using many other computing facilities and techniques without departing from the spirit of the present disclosures. For example, the LMS provider may provide a client-side application, a server side application, a web service to a third party interface provider, and the like.

In various embodiments, the LMS may also collect various information about the merchants and the customers, such as customer satisfaction, merchant's quality of work, merchant's and customer's behavior, timely response, payment habits, credit ratings, and the like to generate, build, and/or update a profile for each to allow a best match or tailoring the matching of customers and merchants for high quality results for both. For example, a lead about a customer with high credit rating may be worth more to a merchant than a lead with a lower rating. Similarly, the quality and timeliness of work performed by a merchant promotes higher customer satisfaction and return business for LMS and the merchants that use its services. In some embodiments, the price at which a lead is sold to a merchant may be set according the quality of work of the merchant. A merchant with a lower quality rating may have to pay more to buy the same lead because a low quality of service may cause the customer not to come back to LMS and thus incur a cost in this way, which is passed on to the merchant. Such customer and merchant profile information may be stored and maintained in a database.

In various embodiments, a consumer as well as a merchant may have one or more calendars. For example, an end-user such as a customer or consumer may have one calendar for work, one for personal use, and another one for school. Similarly, a merchant may have one calendar for customer appointments, one for supplier side events, and one for internal operations. The LMS may construct or generate a new or use an existing lead scheduling calendar, at least partially based on one or more consumer and merchant calendars, to schedule various suppliers or merchants to deliver the requested services or goods to the leads they have purchased, the leads representing the consumer. In some embodiments, LMS may import one or more calendars of the merchant and/or the consumer to coordinate the service. In various embodiments the LMS's lead or service scheduling calendar may be constructed by the scheduling and calendar processing software module based on a combination of one or more calendars associated with the user/customer and one or more of the relevant calendars of the merchant providing the goods and/or services. A service schedule may be determined at least based on free or uncommitted times that time-wise overlap in all the calendars considered (that is, common free times in all calendars.)

In various embodiments, once common uncommitted times are identified, a service time is scheduled based on these times between the consumer and service provider via the LMS 402 computing facilities. For example, the LMS may send a scheduling email or other computer-based messages to the consumer and the merchant asking them to consider the available free times and select one or more time slots for service. Once a common time is agreed upon, the LMS may send a final scheduling notice to finalize the appointment. In some embodiments, if a rescheduling is needed after the final notice, the requesting party may ask the scheduling process to be repeated to find a new time. The LMS may subsequently coordinate messaging between the merchant and the customer, send reminder messages to both about the appointment, assist in modifying the customer order, and reschedule appointments as needed.

FIG. 5 shows an example marketing and advertisement interaction between customers, merchants, and sales LMS. In various embodiments, the marketing and advertising interaction environment 500 includes LMS 502, consumer 504, computer network 506, merchant 508, and dialog box interface 510 used to acquire specific information from the consumer for the services he may need.

In various embodiments, merchants register with LMS to use the marketing and advertising services offered by LMS to promote their products and/or services. The LMS sends messages, such as email, SMS, text, social network messages like wall-writing, and the like, to inform potential market leads of the type of services available from their registered merchants. Such messages may be handled by the appropriate servers such as email servers, SMS or text servers, and the like. Such messages may also include a hotlink to the services provided by the merchant, which the user may select to view. In some embodiments, when the users selects or clicks on the hotlink, the dialog box 510 is presented requesting further information from the user regarding their specific needs, contact information, approximate time-frame for the service, and other preliminary information needed to start the service selection and scheduling process.

In various embodiments, the user may also refer to an LMS website, a public website, or other online or Internet-based facility, such as web portals similar to Yahoo® or MSN®, in search of available services the user may need. The user may also use popular search engines such as Google® and Bing® to search for desired goods or services. The user may then search for and find various merchants that offer the services the user is seeking. After this initial selection step, the LMS may assist in continuing the service scheduling process as described above with respect to FIG. 4. The user may also view LMS advertising on other websites, social networking site advertisements, and other various online and other electronic advertisements. The user may then select a hotlink related to the services he is looking for and be directed to the LMS website for further assistance. Alternatively, the user may be directed to the website of various merchants directly, in which case the source of the hotlink may be identified and/or tracked by embedded tokens in the hotlink as the LMS marketing services, thus involving LMS in subsequent transactions, such as service scheduling, with the customer.

In various embodiments, the LMS may select users for sending marketing messages based on their prior relevant inquiries, profile, or history with LMS. For example, if a user previously asked about or acquired services of a landscape company through LMS, subsequent or periodic marketing messages may be sent to the user offering related services such as tree pruning, spring flower planting, and the like.

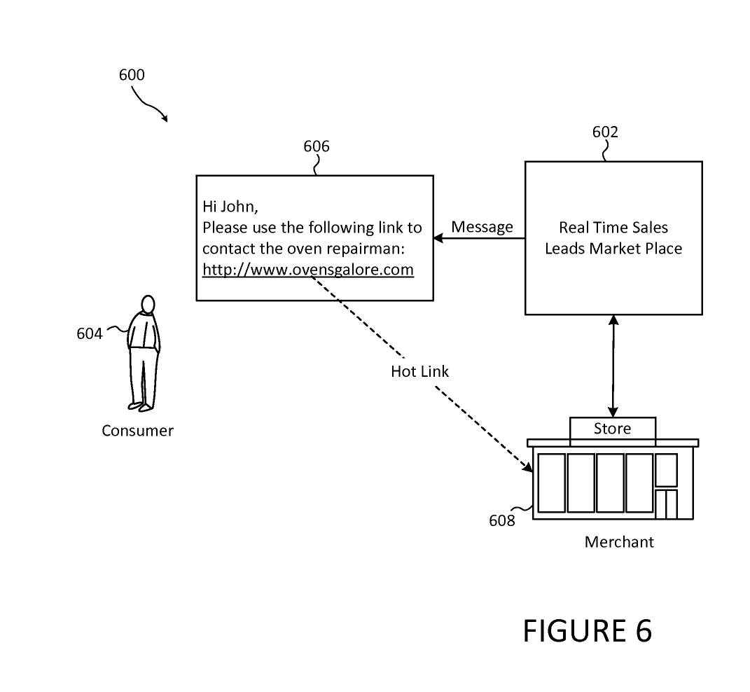

FIG. 6 shows an example messaging interaction between customers, merchants, and sales LMS. In various embodiments, interaction 600 may include LMS 602, consumer 604, message 606, and service provider or merchant 608.

In various embodiments, LMS 602 may send a direct message to a consumer, such as an email with an embedded hotlink to contact a service provider directly or go to a webpage provided by the LMS to continue the process. If the customer is directed to view the merchant's website, a web programming construct, such as HTML iFrame or other similar software mechanism, may be used to display the merchant's website within an LMS website, thus keeping LMS involved for assisting the customer and the merchant in subsequent transactions, such as service scheduling, and profile updates.

It will be understood that each step in the described processes above can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the disclosure.

Accordingly, combinations of steps of the described processes support combinations of means for performing the specified actions. It will also be understood that each step or combination of steps in the described processes can be implemented by special purpose hardware based systems which perform the specified actions or steps, or combinations of special purpose hardware and computer instructions.

It will be further understood that unless explicitly stated or specified, the steps described in a process are not ordered and may not necessarily be performed or occur in the order described or depicted. For example, a step A in a process described prior to a step B in the same process may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A sales Lead Marketplace System (LMS) comprising:
a marketing server;
a messaging module coupled with the marketing server; and
a database server coupled with the marketing server and the messaging module, wherein the marketing server is configured to present consumers with messages including a hotlink to a merchant associated with the LMS to allow the consumers to communicate with the merchant using the hotlink.

2. The system of claim 1, further comprising a scheduling module coupled with the messaging module and configured to merge a consumer calendar and a merchant calendar to determine an uncommitted time for a service appointment.

3. The system of claim 2, wherein the scheduling module creates a lead scheduling calendar based on at least one consumer calendar and one merchant calendar accessed by the LMS.

4. The system of claim 1, wherein the LMS provides electronic marketing and advertising services to the merchant.

5. The system of claim 1, wherein the database server includes information about consumer and merchant profiles.

6. The system of claim 1, wherein the LMS generates consumer and merchant profiles based on at least a history of transactions of the consumer and merchant, respectively.

7. The system of claim 1, wherein the messaging module comprises one of an email server, an SMS server, and a text server.

8. The system of claim 1, wherein the marketing server uses a profile of the merchant and a profile of the consumer to match the merchant and the consumer in an advertising campaign.

9. A method of scheduling sales leads, the method comprising:
retrieving information about a merchant and a consumer using a database server;
matching the merchant and the consumer using a marketing server coupled with the database server based on the retrieved information; and
sending a message to the consumer using a messaging module to the consumer having a hotlink to the merchant.

10. The method of claim 9, further comprising a scheduling an appointment using a scheduling module between the consumer and the merchant.

11. The method of claim 10, wherein scheduling an appointment comprises using at least one consumer calendar and one merchant calendar to determine and appointment time.

12. The method of claim 9, further comprising building a profile of the consumer and a profile of the merchant based on a history of transactions of the consumer and the merchant, respectively.

13. The method of claim 9, wherein retrieving information about the merchant and the consumer comprises retrieving profile information based on a history of transactions of the consumer and the merchant, respectively.

14. The method of claim 9, wherein sending a message to the consumer comprises sending one of an email or an SMS message to the consumer.

15. The method of claim 9, wherein the sales leads are scheduled by a Lead Marketplace System (LMS) comprising the database server, the marketing server, and the messaging module.

16. A method of scheduling a service appointment, the method comprising:
advertising services of a merchant in an electronic format;
receiving an indication from a consumer about interest in the services of the merchant;
retrieving information about the merchant and the consumer from a database server;
matching the merchant and the consumer using a marketing server coupled with the database server based on the retrieved information; and
sending a message to the consumer using a messaging module to the consumer having a hotlink to the merchant.

17. The method of claim 16, further comprising scheduling an appointment using a scheduling module between the consumer and the merchant.

18. The method of claim 16, wherein retrieving information about the merchant and the consumer comprises retrieving profile information based on a history of transactions of the consumer and the merchant, respectively.

19. The method of claim 16, wherein advertising the services of a merchant comprises posting advertisements on a public web portal.

20. The method of claim 16, wherein sending a message to the consumer comprises sending one of an email or an SMS message to the consumer.
